(19) United States
(12) Patent Application Publication
(10) Pub. No.: US 2018/0045471 A1
(43) Pub. Date: Feb. 15, 2018

(54) 3D-PRINTED HEATING SURFACE ELEMENT FOR A PLATE HEAT EXCHANGER

(71) Applicant: LINDE AKTIENGESELLSCHAFT, München (DE)

(72) Inventor: Jörg Dietrich, Edling (DE)

(73) Assignee: Linde Aktiengesellschaft, Munchen (DE)

(21) Appl. No.: 15/552,692

(22) PCT Filed: Mar. 3, 2016
(86) PCT No.: PCT/EP2016/000375

§ 371 Date: Aug. 22, 2017

(30) Foreign Application Priority Data
Mar. 5, 2015 (EP) 15000638.5

(51) Int. Cl. F28F 3/02; B22F 5/10; B22F 3/10; F28D 9/00; B33Y 80/00

(52) U.S. Cl. CPC F28F 3/025; F28D 9/0062; B33Y 80/00; B22F 3/10; B22F 5/10

(57) ABSTRACT

The invention relates to a heating surface element (2, 3) for a plate heat exchanger (10); said heating surface element (2, 3) is designed and provided to be placed between two parallel separation walls (4) of the plate heat exchanger such that a plurality of ducts (31) for holding a fluid is formed. According to the invention, the heating surface element (2, 3) is produced using 3D printing. The invention further relates to a plate heat exchanger and a method for producing a heating element and a plate heat exchanger.

The invention relates to a heating surface element for a plate heat exchanger and to a plate heat exchanger with such heating surface elements and also furthermore to methods for producing such heating surface elements and plate heat exchangers.

The prior art discloses plate heat exchangers that are designed to transfer the heat from a first fluid indirectly to another, second fluid. In this case, the fluids are carried in the plate heat exchanger in separate heat exchange passages. These are in each case delimited by two parallel separating walls of the plate heat exchanger, between which there is respectively arranged a heating surface element that is also referred to as a fin or lamella.

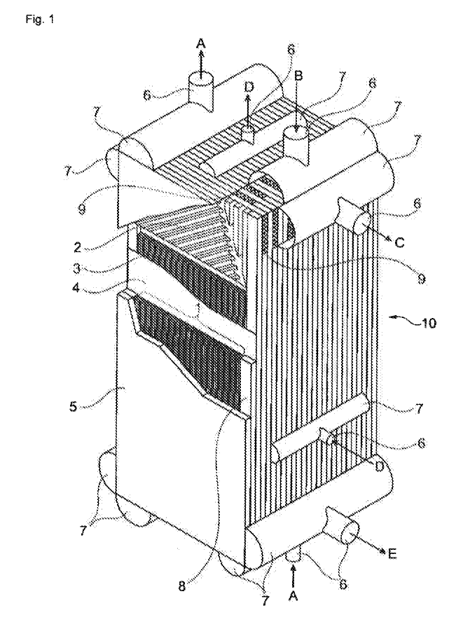

Such plate heat exchangers are shown and described for example on page 5 in “The standards of the brazed aluminium plate-fin heat exchanger manufactures association” ALPEMA, Third Edition, 2010. An illustration taken from it is shown in FIG. 1 as prior art and is described below. The plate heat exchanger shown there comprises a number of separating walls arranged parallel to one another in the form of parting sheets 4, which form a multiplicity of heat exchange passages 1 for the fluids A, B, C, D, E that are to be brought into indirect heat transfer with one another. The heat exchange between the fluids participating in the heat exchange takes place in this case between neighboring heat exchange passages 1, the heat exchange passages 1, and consequently the fluids, being separated from one another by the parting sheets 4. The heat exchange takes place by means of heat transfer by way of the parting sheets 4 and also the heating surface elements (fins) 3 arranged between the parting sheets. The heat exchange passages 1 are closed off from the outside by side strips attached flush to the edge of the parting sheets 4 in the form of sheet metal strips 8 that are also referred to hereinafter as side bars 8. Arranged within the heat exchange passages 1 or between each two parting plates 4 are the corrugated (cross-sectionally meandering) fins 3. The parting sheets 4, fins 3 and side bars 8 are securely connected to one another and thereby form a compact plate heat exchanger 10 or heat exchanger block. The entire plate heat exchanger 10 is outwardly delimited by two outermost outer walls in the form of outer sheets 5. The two outer walls 5 are in this case respectively formed by the outermost separating wall of the plate heat exchanger 10.

For supplying and discharging the heat-exchanging fluids, semicylindrical manifolds 7 with nozzles 6 that serve for connecting supplying and discharging pipelines are attached by way of inlet and outlet openings 9 of the heat exchange passages 1. The manifolds 7 are also referred to as headers 7. The inlet and outlet openings 9 of the heat exchange passages 1 are formed by so-called distributor lamellae or distributor fins 2, which provide a uniform distribution of the fluids among the individual heat exchange passages 1. The fluids flow through the heat exchange passages 1 in the channels formed by the fins 3 and the parting sheets 4.

According to the prior art, the said heating surface elements or fins 3 have a corrugated structure with alternating corrugation troughs and corrugation crests, a corrugation trough being connected in each case to a then following corrugation crest by way of a flank of the heating surface element concerned, so that the corrugated structure is obtained. The channels for carrying the fluid in the respective heat exchange passage 1 are formed by the corrugated structure—together with the separating walls on both sides.

The corrugation crests and corrugation troughs of the corrugated structure are connected to the respectively neighboring parting sheets. The fluids participating in the heat exchange are consequently in direct thermal contact with the corrugated structure, so that the heat transfer is ensured by the thermal contact between the corrugation crests or corrugation troughs and parting sheets. To optimize the heat transfer, the alignment of the corrugated structure is chosen according to the particular application so as to make concurrent flow, cross flow, counter flow or cross-counter flow possible between neighboring passages.

The corrugated structures of the fins within the heat exchange passages perform three tasks. On the one hand, the heat exchange between two fluids in neighboring heat exchange passages is ensured by the thermal contact between the corrugated structure or the fin and the respective parting sheet. On the other hand, the corrugated structures establish the connection with the separating walls. Thirdly, the flanks of the corrugated structure serve for introducing the forces produced by the internal pressure into the connection between the corrugation crest, braze and parting sheet or between the corrugation trough, braze and parting sheet.

Such plate heat exchangers are preferably formed from aluminum, the components being connected to one another by brazing. The heating surface elements (fins) 3, parting sheets 4, distributor fins 2, outer sheets 5 and side bars 8 provided with braze are stacked one on top of the other and subsequently brazed in a furnace to form a heat exchanger block. The headers 7 with nozzles 6 are subsequently welded onto the heat exchanger block.

The heating surface elements or fins 3 are therefore brazed to the parting sheets 4 at their contact points that are formed by the corrugation crests and corrugation troughs, whereby an intensive heat conducting contact is established between the fins 3 and the parting sheets 4. As a result, the heat exchange between the various fluids that flow alternately in neighboring heat exchange passages 1 is improved.

As a result of this production method, the maximum size of such a heat exchanger block is of course also dictated by the size and geometry of the brazing furnace.

Furthermore, according to the prior art, the heating surface elements or fins 3 are generally produced from thin metal sheets, which are folded into corrugated structures by a press or other tools suitable for the deforming operation. Due to the boundary conditions that have to be maintained in the respective forming process, such as radii at the transition between the corrugation crest or corrugation trough and flank, and the tolerances occurring in the forming process with regard to the ideal form to be achieved, the mechanical strength of the resulting plate heat exchanger is limited, which presents problems in an application with media under high pressures and/or high temperatures.

Furthermore, in the case of such forming processes the geometry of the fin to be produced is substantially predetermined by the available press tools.

In the production of plate heat exchangers, the possible forms of the fins available are therefore significantly limited, so that often the process-engineering, hydraulic or static requirements cannot be satisfied completely, or to the extent actually desired. In particular, it is often the case with the said forming methods for fins that undercuts of whatever kind desired cannot be produced, in particular undercuts that run transversely to the pressing direction.

Against this background, the present invention is based on the object of providing a heating surface element and a plate heat exchanger and also corresponding methods for producing such devices that make a more flexible design of the heating surface elements and plate heat exchangers possible.

The features according to the invention are provided by the independent claims, advantageous refinements of which are presented in the dependent claims. The features of the claims may be combined in any technically meaningful way, it also being possible to use for this the explanations from the following description and features from the figures, which cover additional refinements of the invention.

The object on which the invention is based is achieved by a heating surface element with the features of claim 1, which is designed and intended for being arranged between two parallel separating walls of the plate heat exchanger, so that a multiplicity of channels for receiving a fluid are formed, the heating surface element being produced according to the invention by 3D printing, and the heating surface element having at least a first portion and a second portion, which are formed one on the other in one piece, the two portions together with the two separating walls respectively forming channels for receiving the fluid, and in each case a channel of the first portion being in flow connection with at least one channel of the second portion, and the channels of the first portion running in a different direction than the channels of the second portion.

There is also the possibility that, although the channels of the two portions point in the same direction, the two portions of the heating surface element have a different geometry, in particular in cross section. Such a different geometry may of course also apply in the case where the channels of the two portions point in different directions.

Preferably, the heating surface element according to the invention, which is also referred to as a fin, has a corrugated structure with alternating corrugation troughs and corrugation crests, in each case a corrugation trough being connected to a then following corrugation crest by way of a flank of the heating surface element, so that the corrugated structure is obtained. The corrugated structure does not necessarily have to be formed in a rounded manner, but may also be formed in a rectangular manner. What is essential in this respect is a cross-sectionally meandering course of the heating surface element, so that it can extend back and forth between two separating walls in each case of the plate heat exchanger.

The production of the heating surface element by means of 3D printing means that the production of respectively adapted heating surface elements for an individual requirement can be implemented at low cost.

According to one embodiment of the heating surface element according to the invention, it is preferably produced by means of laser sintering from a metal, in particular from aluminum.

In the case of such a 3D printing method, the heating surface element is built up layer by layer from a powdered material, in particular comprising a metal, in particular aluminum, a number of layers of the material being successively applied one on top of the other, each layer before the application of the next following layer being heated for example by means of a laser beam (in particular focused on the layer) in a predefined region that corresponds to a cross-sectional region of the heating surface element to be produced, and thereby fixed on the layer lying thereunder, in particular fused to it.

3D printing therefore makes available printing materials that are then bonded to one another by at least partial melting or incipient melting of the surface. The 3D printing method is accordingly a generative method which also allows the production of undercuts that generally cannot be obtained, or only comparatively laboriously, when casting or pressing (for example when casting by means of a lost core).

In the case of such 3D printing, in particular an interfacial diffusion of the material involved is achieved, so that the existing material is formed with the newly added material as if produced from one piece. In this way it is possible overall to form a heating surface element in one piece which has the optimum form with regard to the respective use that is not subject to the limitations applying in the case of forming or casting processes.

According to a further advantageous embodiment of the heating surface element, it has at least one undercut, which extends in a direction that runs parallel to a plane of extent of the heating element and in particular perpendicular to the said channels of the heating surface element that are formed by the corrugated shape of the fin.

On account of the layer-by-layer buildup according to the invention of the heating surface element, it can in principle have all conceivable undercuts in any desired directions. By contrast, with the production methods used until now undercuts often have to be avoided, since otherwise it is necessary for example to use lost molds (in the case of casting) or multi-axis milling methods.

As already stated above, it is also provided that the heating surface element according to the invention has at least a first portion and a second portion (or a number of portions), the two portions respectively forming channels for receiving the fluid and being formed one on the other in one piece by 3D printing. Preferably, one channel of the first portion in each case is flow-connected to at least one channel of the second portion, the channels of the first portion preferably running in a different direction than the channels of the second portion.

Thus, for example, the first portion may be formed as an inlet portion of the heating surface element, which has at the end face inlet openings that are in flow connection with the channels of the first portion, so that a fluid can be fed into the channels of the first portion by way of the inlet openings, and furthermore can be distributed by the channels of the first portion among the channels of the second portion, which here forms in particular a main portion of the heating surface element.

In this way, the heating surface element can therefore have the so-called distributor fins (inlet portion) integrally in an advantageous way.

Alternatively, the first portion may also be formed as an outlet portion of the heating surface element, which has at the end face outlet openings that are in flow connection with the channels of the first portion or outlet portion, so that a fluid can be drawn off from the first portion (outlet portion) in particular by way of the outlet openings, and the channels of the first portion being respectively in flow connection with at least one channel of the second portion (for example central main portion), so that a fluid can be drawn off out of the heating surface element from the second portion or main portion of the heating surface element by way of the first portion (outlet portion) and its outlet openings.

Furthermore, the heating surface element according to the invention may also have a third portion, which is formed integrally (by 3D printing) on the first or the second portion. The first portion may in this case form an inlet portion of the kind described above and the third portion may form an outlet portion described above. The second portion would in this case form the so-called main portion, which is arranged in the flow path of the fluid, in particular between the first portion and the second portion of the heating surface element.

It is preferably also provided that the channels run in a curved manner, in particular in the individual portions. Thus, in particular the channels in the inlet portions may run in a curved manner toward the inlet openings. Furthermore, the channels in the outlet portion may run in a curved manner toward the outlet openings.

In principle, as a result of the way in which they are produced by means of 3D printing, the channels of the heating surface element (in particular in the individual portions) can run in different directions and/or have different geometries.

The 3D printing of the heating surface element makes it possible in an advantageous way that for example the inlet and outlet portions on the one hand and the main portion of the heating surface element on the other hand go over into one another without any transition. As a result, offsets and butt joints of heating surface elements (fins) in a passage are avoided.

According to a further embodiment of the heating surface element according to the invention, it is provided that it also has reroutings or intermediate feeds and intermediate discharges in a integral way, i.e. apart from the heating surface element itself and the surrounding outer plates, and possibly supplying and discharging nozzles, there are preferably no further separate elements of the heating surface element that perform or are involved in the said rerouting or intermediate feeding and intermediate discharging operations.

It is also provided according to a preferred embodiment that the geometry of the heating surface element within a passage varies from portion to portion, for example with respect to the division thereof or other geometrical parameters. As a result, in a passage in which the heating surface element according to the invention is arranged, individual or multiple process parameters, such as for example the flow rate of the fluid (and consequently in particular also the heat transfer), can be adapted exactly to the respective requirements in the corresponding portion of the heating surface element.

It is particularly preferably provided that the heating surface element according to the invention is formed completely integrally/in one piece within one layer or over the respective entire layer of the plate heat exchanger. This allows in particular cutouts, perforations and/or offsets of the heating surface element also to be integrally incorporated and also to vary from portion to portion.

According to a further aspect of the invention, a plate heat exchanger for the indirect transfer of heat of a first fluid to a second fluid is proposed, the plate heat exchanger having a multiplicity of separating walls, in particular parallel separating walls, a heating surface element according to the invention, for example in accordance with the description above, being arranged in each case between two separating walls.

The separating walls are designed to separate two fluids involved in the heat exchange from one-another, so that no mass transfer takes place between the two fluids. At the same time, the respective separating wall is preferably formed with particularly good heat conduction, so that a heat transfer from one fluid to the other fluid is possible. In order to increase the contact surface and obtain a pressure-bearing connection of neighboring separating walls and also to provide flow channels, the heating surface elements are provided between the separating walls. The freedom of the formation of the heating surface elements allows a very good heat transfer to be obtained along with great stability of the heating surface element and low flow resistance in the individual channels.

According to a refinement of the invention, it is conceivable to produce only the heating surface elements by 3D printing of the kind described above and to perform the remaining construction of the plate heat exchanger in the known manner, for example by stacking and brazing the components in a furnace (see above).

According to a further refinement of the invention, it is provided that, in addition to the heating surface elements, at least one or more further components of the plate heat exchanger is or are produced by 3D printing. This may be for example one or more or all of the separating walls, outer walls, nozzles, manifolds and/or side bars of the plate heat exchanger. If a number of components are produced by 3D printing, whenever they adjoin one another they are preferably produced or 3D-printed in one piece, i.e. integrally. That is to say that they are 3D-printed together layer by layer as a single subassembly.

According to a preferred embodiment, it is provided that the entire plate heat exchanger is formed in one piece by 3D printing.

In spite of the integral form of its components, in particular the heating surface elements, such a plate heat exchanger has a greater degree of production freedom than previously known methods for the individual components (for example forming, casting, milling); this is so because accessibility is less critical as a result of the layer-by-layer, generative production. In particular with production by means of 3D printing, in which no finishing is necessary, it is not necessary for production to make allowance for a possible undercut.

Forming the said components or the entire plate heat exchanger by 3D printing allows considerable savings to be made with regard to material and assembly. Most particularly, exact adaptation to the load case is possible. By contrast with previously known methods, there is less or even no additional material required just because of the separate production of the components or necessary for a joining process. Previously, many components had to be designed for a joining method, for example brazing or welding, and for these connecting processes had to have a much greater area and/or different form in order to ensure that a sufficient strength of the respective joining connection can be produced. Most particularly preferably, an outer wall of the plate heat exchanger, which outwardly delimits the individual heat exchange passages, is formed by 3D printing in one piece with at least the separating walls and/or at least the heating surface elements, preferably all the components in the interior of the plate heat exchanger, a transition that is optimum in terms of stress being formed in particular with respect to the outer wall.

According to a further aspect of the present invention, a method for producing a heating surface element, in particular a heating surface element according to the invention, for a plate heat exchanger is proposed, said element being designed and intended for being arranged between two parallel separating walls of the plate heat exchanger, so that a multiplicity of channels for receiving a fluid are formed. According to the invention, it is provided here that the heating surface element is produced by 3D printing, in particular the heating surface element being produced by 3D printing, in particular laser sintering, from a metal, in particular from aluminum.

With respect to the 3D printing, it is preferably provided that the heating surface element is built up layer by layer from a powdered material, in particular comprising a metal, in particular aluminum, a number of layers of the material being successively applied one on top of the other, each layer before the application of the next following layer being heated by means of a laser beam (in particular focused on the layer) in a predefined region that corresponds to a cross-sectional region of the heating surface element to be produced, and thereby fixed on the layer lying thereunder, in particular fused to it.

Building up the heating surface element in such an interfacially diffusive way from individual layers that are formed one on the other has the effect of forming a one-piece element that can have the material strength properties of a corresponding solid material. In particular, the boundary surfaces of the respective layers are diffusively bonded to one another. That means, in particular in the case of a metal, particularly preferably aluminum, crystals that extend over the boundary surfaces of the joined material portions are formed. The fusable material is particularly preferably made available in particle form (for example as a powder), the particles being able to be melted in their entirety or only the surface thereof, it being possible for the particles of the powder to be coated with a binder.

Furthermore, according to one aspect of the invention, the production of a plate heat exchanger, in particular a plate heat exchanger according to the invention, is proposed, at least the heating surface elements of the plate heat exchanger, and also in particular at least one further component of the plate heat exchanger, preferably the entire plate heat exchanger, being produced by 3D printing, in particular by laser sintering, in particular from a metal, in particular aluminum. The production of the plate heat exchanger from a metal makes it particularly stable and robust with respect to environmental influences.

In the production of the plate heat exchanger or individual or multiple components of the plate heat exchanger, it or the components concerned, such as for example fins, separating walls, outer walls, side bars, headers and nozzles, is/are preferably built up layer by layer from a powdered material, in particular comprising a metal, in particular aluminum, a number of layers of the material being successively applied one on top of the other, each layer before the application of the next following layer being heated by means of a laser beam (in particular focused on the layer) in a predefined region that corresponds to a cross-sectional region of the plate heat exchanger to be produced or the respective component, and thereby fixed on the layer lying thereunder, in particular fused to it.

In particular, even external line connections, i.e. manifolds and/or nozzles, can in this way be formed onto the heat exchanger block in one piece by means of 3D printing. In the case of such external line connections, welded-on connections or manifolds and nozzles that have to be very carefully joined together (for example by welding) to avoid leakages have previously been used. The one-piece form advantageously makes it possible to dispense with such joining steps in the production of the plate heat exchanger.

A further aspect of the present invention concerns a heating surface element that is designed and intended to be arranged between two parallel separating walls of the plate heat exchanger, so that a multiplicity of channels for receiving a fluid are formed, according to the invention the heating surface element being produced by 3D printing. This subject matter of the invention can be developed by the features described herein, in particular by the feature of claim 1, which concerns the two portions, and/or by one or more of the subclaims.

The invention described above is explained in detail below against the relevant technical background with reference to the associated drawings, which show preferred refinements and in which:

FIG. 1 shows a plate heat exchanger of the prior art;

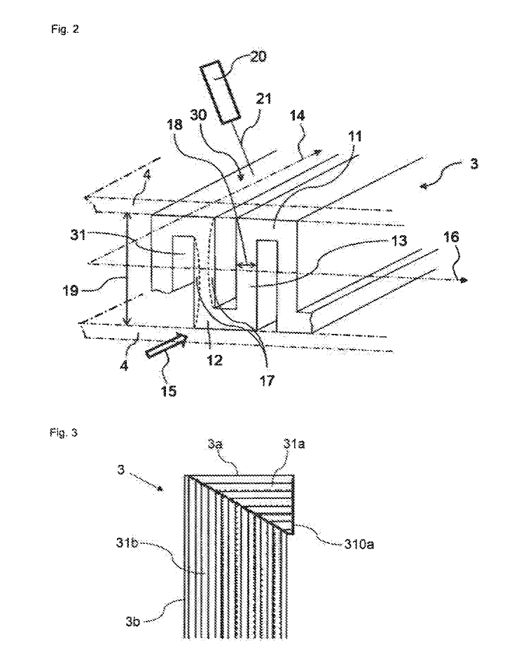

FIG. 2 shows a heating surface element according to the invention; and

FIG. 3 shows a heating surface element according to the invention with an inlet or outlet portion formed on in one piece.

Shown by way of example in FIG. 2 is a heating surface element or fin 3 according to the invention, which is produced by 3D printing, here laser sintering, the heating surface element 3 being produced layer by layer from a powdered material, for example comprising aluminum powder, in that a number of layers of the material are successively applied one on top of the other, each layer before the application of the next following layer being heated by means of a laser beam 21 generated by a laser 20 in a predefined region that corresponds to a cross-sectional region 30 of the heating surface element 3 to be produced, and thereby fixed on the layer lying thereunder, in particular fused to it. Other 3D-printing methods are of course also conceivable.

In this way, a one-piece fin 3 formed in any way desired can be produced, here extending along a plane of extent that runs parallel to the adjacent separating walls 4 of the later plate heat exchanger, between which the heating surface element 3 is to be arranged. With the method according to the invention, the separating walls 4 may of course also be produced integrally with the fin 3 by the 3D printing. Furthermore, the entire plate heat exchanger 10 shown in FIG. 1 can be produced in this way, to be precise in particular by 3D printing of the individual components (for example fins 3, separating walls 4, outer walls 5, fins 2, 3, manifolds 7, nozzles 6, side bars 8) or by integral 3D printing of multiple or all the components (i.e. the entire plate heat exchanger 10). FIG. 1 also shows in this respect an exemplary embodiment of the present invention.

In the exemplary embodiment according to FIG. 2, the individual layers from which the heating surface element 3 is or has been built up respectively extend parallel to the separating walls 4 of the plate heat exchanger, i.e. the individual layers are arranged one on top of the other in the direction of the height 19 of the heating surface element 3. The buildup of the layers may however also take place in some other direction. In the present case, during the 3D printing the heating surface element 3 is given a corrugated structure, in which a multiplicity of corrugation troughs 12 and corrugation crests 11 are arranged alternately one behind the other in a first direction 16, which extends parallel to the separating walls 4. Neighboring corrugation troughs 12 and corrugation crests 11 are each connected to one another in one piece by a flank 13 of the heating surface element 3, so that together with the separating walls 4 a multiplicity of channels 31 in which a fluid can flow are delimited, to be precise parallel to the separating walls 4 and also perpendicular to the first direction 16. The two separating walls 4 shown and the heating surface element 3 in this way form a heat exchange passage of the plate heat exchanger. In the case of an integrally 3D-printed plate heat exchanger, the corrugation crests 11 and corrugation troughs 12 of the fin 3 are formed onto the respectively adjacent separating wall 4 in one piece.

The production according to the invention of the fin 3 makes it possible in an easy way to obtain for example undercuts 17, for example in the form of concave recesses in the flanks 13 (represented here by dashed lines), which extend for example along the first direction 16 and are much more difficult to produce by other production methods (see above). Furthermore, the 3D printing also makes it possible to adapt the thickness 18 of the heating surface element 3 to the value necessary in each case, for example with regard to the pressure to be borne.

FIG. 3 shows a further embodiment of a heating surface element 3 according to the invention, which in turn is to be arranged between two separating walls or between a separating wall and an outer wall of a plate heat exchanger 10. In the case of the heating surface element 3 according to FIG. 3, for example the distributor fin 3a (compare for example the distributor fin 2 according to FIG. 1) now represents an integral component part of the heating surface element 3.

To be specific, the heating surface element 3 according to FIG. 3 has at least a first portion 3a (forms for example the distributor fin) and also a second portion 3b, the two portions 3a, 3b respectively forming channels 31a, 31b for receiving a fluid involved in the heat exchange and being formed one on the other in one piece by 3D printing. Here, in each case a channel 31a of the first portion 3a is preferably in flow connection with at least one channel 31b of the second portion 3b. As can be seen from FIG. 3, the channels 31a of the first portion 3a run in a different direction than the channels 31b of the second portion 31.

As already indicated, the first portion 31a may be for example an inlet portion 3a or a distributor fin of the heating surface element 3, which has at the end face inlet openings 310a that for example open out into an outer side of the plate heat exchanger 10 (cf. FIG. 1i) and are in flow connection with the channels 31a of the inlet portion 31a, so that a fluid can be fed into the channels 31a of the inlet portion 31a by way of the inlet openings 310a, and furthermore can be distributed by the channels 31a of the inlet portion 31a among the channels 31b of the second portion 31b, which here forms for example a main portion 31b of the heating surface element 3 that serves primarily for the heat transfer between the fluid carried in the main portion 31b and at least one further process stream.

Furthermore, the first portion 31a may of course also be formed as an outlet portion of the heating surface element which has outlet openings 310a that are in flow connection with the channels 31a of the first portion or outlet portion 31a, so that in particular a fluid can be drawn off from the outlet portion 31a by way of the outlet openings 310a, and the channels 31a of the outlet portion being respectively in flow connection with at least one channel of the second portion 31b, so that a fluid can be drawn off out of the heating surface element 3 from the second portion (for example main portion, see above) 31b by way of the outlet portion 31a and its outlet openings 310a.

Of course, both the inlet and outlet portions may be formed on a main portion of a heating surface element 3 in one piece by corresponding 3D printing. The main portion of the heating surface element may be arranged here in the flow path of the fluid carried by it, between the inlet portion and the outlet portion.

According to FIG. 3, the channels 31a of the first portion 3a meet the channels 31b of the second portion 3b at an angle. As an alternative to this, the channels 31a of the first portion 3a may of course also run from the channels 31b of the second portion 3b in a curved manner toward the inlet and outlet openings 310, respectively. With the heating surface element 3 or plate heat exchanger proposed here and their production methods, a geometry that is optimum in terms of flow for individual applications can be created at low cost.

List of designations

| | |
|---|---|
| 1 | Heat exchange passage |
| 2 | Distributor fin |
| 3 | Lamella, fin |
| 3a, 3b | Portions |
| 4 | Separating wall |
| 5 | Outer wall |
| 6 | Nozzle |
| 7 | Manifold (header) |
| 8 | Side bar |
| 9 | Inlet opening and outlet opening |
| 10 | Plate heat exchanger |
| 11 | Corrugation crest |
| 12 | Corrugation trough |
| 13 | Flank |
| 14 | Direction of flow |
| 15 | Incident flow |
| 16 | First direction |
| 17 | Undercut |
| 18 | Sheet thickness |
| 19 | Height of the fin perpendicularly to its plane of extent |
| 20 | Laser |
| 21 | Laser beam |
| 30 | Cross-sectional region |
| 31, 31a, 31b | Channel |
| 310a | Inlet or outlet openings |

1. A heating surface element for a plate heat exchanger, which is designed and intended for being arranged between two parallel separating walls of the plate heat exchanger, so that a multiplicity of channels for receiving a fluid are formed, characterized in that the heating surface element is produced by 3D printing, the heating surface element having at least a first portion and a second portion, the two portions being formed one on the other in one piece, and in each case a channel of the first portion being in flow connection with at least one channel of the second portion, and the channels of the first portion running in a different direction than the channels of the second portion.

2. The heating surface element as claimed in claim 1, characterized in that the heating surface element is produced by 3D printing.

3. The heating surface element as claimed in claim 1, characterized in that in the 3D printing the heating surface element is built up layer by layer from a powdered material, comprising a metal, a number of layers of the material being successively applied one on top of the other, each layer before the application of the next following layer being heated by means of a laser beam in a predefined region that corresponds to a cross-sectional region of the heating surface element to be produced, and thereby fixed on the layer lying thereunder fused to it.

4. The heating surface element as claimed in claim 1, characterized in that the heating surface element has at least one undercut, which extends in a first direction that runs parallel to a plane of extent of the heating element and in particular perpendicular to the said channels.

5. The heating surface element as claimed in claim 1, characterized in that the first portion forming is selected from the group consisting of is formed as an inlet portion of the heating surface element, which has inlet openings that are in flow connection with the channels of the first portion, so that a fluid can be fed into the channels of the first portion by way of the inlet openings, and furthermore can be distributed by the channels of the first portion among the channels of the second portion,
and in that the first portion is formed as an outlet portion of the heating surface element, which has outlet openings that are in flow connection with the channels of the first portion, so that a fluid can be drawn off from the first portion by way of the outlet openings, and the channels of the first portion being respectively in flow connection with at least one channel of the second portion, so that a fluid can be drawn off out of the heating surface element from the second portion by way of the first portion and its outlet openings.

6. The heating surface element as claimed in claim 1, characterized in that the channels of the first and/or the second portion run in a curved manner toward the inlet or outlet openings.

7. The heating surface element as claimed in claim 1, characterized in that the channels run in different directions and/or have different geometries.

8. A plate heat exchanger for the indirect transfer of heat of a first fluid to a second fluid, the plate heat exchanger having a multiplicity of parallel separating walls, a heating surface element characterized in that the heating surface element is produced by 3D printing, the heating surface element having at least a first portion and a second portion, the two portions being formed one on the other in one piece, and in each case a channel of the first portion being in flow connection with at least one channel of the second portion, and the channels of the first portion running in a different direction than the channels of the second portion being arranged in each case between two separating walls.

9. The plate heat exchanger as claimed in claim 8, characterized in that, in addition to the heating surface elements, at least one or more of the following components of the plate heat exchanger is or are produced by 3D printing:
a separating wall,
an outer wall,
a nozzle,
a manifold, or
a side bar.

10. The plate heat exchanger as claimed in claim 8, characterized in that the entire plate heat exchanger is formed in one piece by 3D printing.

11. A method for producing a heating surface element for a plate heat exchanger, said element being designed and intended for being arranged between two parallel separating walls of the plate heat exchanger, so that a multiplicity of channels for receiving a fluid are formed, characterized in that the heating surface element is produced by 3D printing.

12. The method as claimed in claim 11, characterized in that in the 3D printing the heating surface element is built up layer by layer from a powdered material comprising a metal a number of layers of the material being successively applied one on top of the other, each layer before the application of the next following layer being heated by means of a laser beam in a predefined region that corresponds to a cross-sectional region of the heating surface element to be produced, and thereby fixed on the layer lying thereunder fused to it.

13. A method for producing a plate heat exchanger having a multiplicity of parallel separating walls, a heating surface element, the heating surface element having at least a first portion and a second portion, the two portions being formed one on the other in one piece, and in each case a channel of the first portion being in flow connection with at least one channel of the second portion, and the channels of the first portion running in a different direction than the channels of the second portion being arranged in each case between two separating walls characterized in that at least the heating surface elements of the plate heat exchanger, and also at least one further component are produced by 3D printing.

14. The method for producing a plate heat exchanger as claimed in claim 13, characterized in that at least the heating surface elements of the plate heat exchanger, and also in-particular at least one further component, are built up in the 3D printing layer by layer from a powdered material comprising a metal, a number of layers of the material being successively applied one on top of the other, each layer before the application of the next following layer being heated by means of a laser beam in a predefined region that corresponds to a cross-sectional region of the plate heat exchanger to be produced, and thereby fixed on the layer lying thereunder fused to it.
